(19) United States
(12) Patent Application Publication
(10) Pub. No.: US 2005/0162670 A1
(43) Pub. Date: Jul. 28, 2005

(54) Method for evaluating and recommending digital image print size with ordering and overlapped file upload

(76) Inventor: Robert Luckett Shuler JR., Friendswood, TX (US)

Correspondence Address: Robert L. Shuler, Jr., 5238 Appleblossom Lane, Friendswood, TX, 77546, US

(21) Appl. No.: 10/765,344

(22) Filed: Jan. 27, 2004

(51) Int. Cl. G06F 15/00

(52) U.S. Cl. 358/1.2

(57) ABSTRACT

A system and method is capable of evaluating and recommending digital image print size, with a user interview for specifying an image file and a requested print size width and height, an image reader for determining the pixel dimensions of the image, an evaluator for determining acceptable viewing distance based on a predetermined limit of acceptable pixel enlargement, an evaluator for preserving image aspect ratio, and a display for showing results of the evaluation, whereby quality issues arising from users attempting too much enlargement are minimized, and delays arising from questions about enlargement size or mis-matched aspect ratios are minimized. The system and method is capable of providing for overlapped file upload to minimize print services ordering time and increase the likelihood that orders arrive at a print services provider together with the image file to be printed.

### DESCRIPTION OF ATTACHED APPENDIX

The computer program listing appendix submitted on compact disk in MS Windows format constitutes a part of this specification and includes exemplary embodiments of the invention, which may be embodied in various forms. The following files are contained on the compact disk:
wizard.htm created Jan. 25, 2004, 3256 bytes
wizardf.htm created Jan. 25, 2004, 23220 bytes
wizardb.htm created Jan. 25, 2004, 426 bytes
printorder.htm created Jan. 25, 2004, 33782 bytes
printorder.cgi created Jan. 25, 2004, 24899 bytes
printupd.cgi created Jan. 25, 2004, 19576 bytes
mcp_dscan.cgi created Jan. 25, 2004, 70411 bytes
mcp_report.cgi created Jan. 25, 2004, 57068 bytes
mcp_reports.htm created Jan. 25, 2004, 7349 bytes

### BACKGROUND OF THE INVENTION

This invention relates generally to the field of image reproduction or print services and more specifically to an improved method for evaluating and recommending digital image print size with ordering to ensure high quality and a consistent aspect ratio.

Image reproduction or print services have long been divided into a retail segment and a mail order segment. With the growth of the internet, the introduction of digital cameras, and software to manipulate or produce digital images, the mail order segment has become both more convenient and more complex.

The complexity leads to problems, with the result that all high volume commercial services are based on the sizes and prices associated with older film technology. Digital printing has not been fully exploited because the order complexity and resulting customer dissatisfaction rate make it unprofitable at reasonable price levels, and print service providers have not understood how to implement order processing systems that solve these problems. Since consumer digital photography, digital printing and the internet have been in widespread use for about a decade without commercial offerings employing good solutions, we can conclude such solutions are not obvious.

Several types of problems arise when profiding large format printing services for digital image technology. The expanded image source types and consumer unfamiliarity with them cause order flow problems and high re-do rates. Arcane terms such as “pixels” and “printer dots” confuse both users and service providers because they are not equivalent, and may be misleading as a sole indication of quality. After image processing or cropping by a user, an image may be of arbitrary dimensions, and may not fit any standard size, or may not even match the size the user is requesting. Solutions to the order flow problems are not obvious. Devising a cost effective method of implementing a solution is not trivial.

With film based services, identification of the source film type allows problems of aspect ratio and enlargement size to be alleviated by offering only certain standard sizes, or by advising for or against certain sizes and aspect ratios based on the customer's film type. When known, the exposure factor may also be taken into account. Committees of observers, such as described by Cloutier, et. al. U.S. Pat. No. 6,018,397 have been used to establish quality thresholds. Sekiya U.S. Pat. No. 6,259,824 discloses a neural network approach to learning the quality preferences of a single specific user.

Traditionally print services have either used internally or offered to the consumer “proof” prints used in assessing quality. Sakai, et. al. U.S. Pat. No. 6,088,138 describe use of an electronic display to preview a magnified image to screen for print quality, avoiding the need for proof prints. Sakai and Cloutier appear to disagree on the usefulness of electronic displays in assessing print quality.

With a film-based print service, all source images may be assumed to be photographs. If an inappropriate use is made of film technology, it is assumed to be the consumer's fault. This cultural mindset protects the service provider and simplifies his task.

Early in the development of digital output devices for color prints their quality was often inferior to photographic reproductions, and this had to be taken into account. Color quality was also often an issue. Cloutier, et. al. describe output device quality considerations. Nako U.S. Pat. No. 6,028,676 discloses considerations specific to the memory storage capability of the output device. However, modern commercial equipment removes these limitations and considerations as far as most consumers are concerned.

Kinjo U.S. Pat. No. 6,590,671 attempts to formulate a highly automated approach to using the internet in a print ordering system, but since it is still conceptually film based it avoids the problems of non-film image sources, and suffers the drawback of requiring special equipment to scan the film at the order origination point.

Because of the large variation in source material, when large format digital print services are offered to the general public many people will request too large a size or an incorrect aspect ratio that does not match their source image. If these orders were printed as specified, customers would be disappointed with the poor resolution or unexpected cropping or stretching of their images. Another category of customer will request sizes too small to be economically printed, not taking advantage of the resolution available in their high quality images to print them larger, which would result in greater customer satisfaction and greater revenue for the print service provider. Still a third category of customer will transmit image files much larger than necessary for the required image quality, clogging up the provider's server, taking more time to upload than the user is willing to spend, and resulting in lost orders or special handling for files sent via CDROM or other means.

When orders are placed via the internet the customer is not present, and such requests as described above will take up a great deal of time for personnel to evaluate files and interact with customers via email or telephone. Some customers may be slow to respond to email inquiries, may not understand the service provider's question since a visual problem is being explained to them in words, or may not be reachable at all due to reluctance to supply a working email address. When an order has to be re-done due to customer complaint, not only are time and materials lost, but also shipping, which may be a substantial part of the cost of filling an order. When a customer is not completely satisfied, even if a re-do is not requested, repeat business may be lost.

Digital source images may contain digitally generated lettering and straight-line high contrast edges that would not be found in photographs of natural objects where lighting and focusing soften all edges. Lettering and straight lines in digital images will present an unpleasant and unnatural jaggy appearance when enlarged as much as a similar size photograph could be enlarged. Quality guidelines based on source image size will not suffice for such material.

Digital source images may also be scans of traditional photographs or of other images printed on paper. In this case, the resolution of the source image file may be quite high due to a high scanning density. However, this does not guarantee that the image can be enlarged to the full extent one would infer from the size of the source image. The resolution of images printed on paper is limited, and all over-scanning does is produce a photo-micrograph of the fibrous structure of the paper, not a higher resolution image.

Electronic display of a preview or “proof” image to an end-user at their home computer is not sufficient to ensure quality for several reasons. The user's display means is not large enough to represent the full area of a large print. When scrolling around in a window on the full image, the user will be sitting closer to the display than one would view the actual print, biasing the estimate of quality. It is difficult to provide the means to display all possible image types on the user's computer, and to determine accurately the viewing characteristics of the user's display.

The enlargement size recommendations of panels of observers, usually neutral or perhaps biased toward higher quality, do not capture the perspective of the consumer who may perceive emotional value in an image. Such recommendations may be unnecessarily conservative, resulting in lost revenue opportunity. An individual customer will not place as many orders with a print service as they would produce on their home printer, and may be discouraged if the first order is not of the expected quality, so an individual-based neural net or other learning system is not particularly effective for a print service.

Many graphics software packages are available for users to purchase or download, but all these require expert knowledge and do not directly provide estimates of print quality or recommendations on image or print size. For all of these packages, it is difficult to figure out how to display an image at its actual printed size. Such packages recommend to the user very high density file sizes which are needed for graphics operations such as rotation, but which produce unnecessarily large files for printing, resulting in the file problems mentioned above. The aforementioned confusion between pixels and printer dots may also lead users to produce overly large image files.

The long and tedious process of correctly specifying an order for large format print services and uploading a large file also may discourage some users, or they may abandon the order process before completing the file upload.

### BRIEF SUMMARY OF THE INVENTION

The primary object of the invention is to pre-screen the image quality of large-format print orders, avoiding customer complaints and re-do's.

Another object of the invention is to qualify the aspect ratio of print orders, avoiding time consuming customer interaction over cropping and stretching.

Another object of the invention is to automatically recommend a print size to customers who are uncertain how much enlargement to request.

Another object of the invention is to ensure that the file the customer is evaluating is the one associated with the order, avoiding mix ups.

A further object of the invention is to provide a means of performing an interactive specification or evaluation independently of a file upload process to ensure that the customer who places an order uploads the associated image file in a timely manner, or if file uploading occurs first to ensure that the associated order is placed in a timely manner, and to reduce the rate of users abandoning orders due to impatience with the upload process.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a system for evaluating and recommending digital image print size comprising: a user interview means for specifying an image file, a requested print size width and height, and an image type, an image reader means for determining the pixel dimensions of the image, a first evaluation means for determining acceptable viewing distance based on a predetermined limit of acceptable pixel enlargement for each image type, a second evaluation means for determining if the requested print size alters the aspect ratio of the image by more than a predetermined amount, and a display means for showing results of the evaluation whereby quality issues arising from users attempting too much enlargement are minimized, and delay when requesting such enlargements from a print service is eliminated.

In accordance with a preferred embodiment of the invention, there is disclosed a method for evaluating and recommending digital image print size comprising the steps of: interviewing a user to select an image file and specify requested print size width and height, reading an image file to determine the pixel dimensions of the image, determining acceptable viewing distance based on a predetermined limit of acceptable pixel enlargement, and displaying the results of the evaluation.

In accordance with a preferred embodiment of the invention, there is disclosed a method for evaluating and recommending digital image print size with ordering and overlapped file upload comprising the steps of: interviewing a user to select an image file and specify requested print size width and height, uploading the image file to an online storage while continuing with the following steps, evaluating the image file print quality at the requested size and displaying the results, obtaining order information associated with the specified file from the user, authorizing payment based on the order information, recording the order and payment authorization information in the online storage, and removing uploaded files for which no order was recorded within a predetermined period of time.

### BRIEF DESCRIPTION OF THE DRAWINGS

The drawings constitute a part of this specification and include exemplary embodiments to the invention, which may be embodied in various forms.

FIG. 1 is a schematic block diagram of the digital image print size evaluation method.

FIG. 2 is a schematic block diagram of the digital image print size evaluation system with DHTML implementation and ordering.

FIG. 3 is a schematic block diagram of the digital image print size evaluation method with overlapped file upload.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

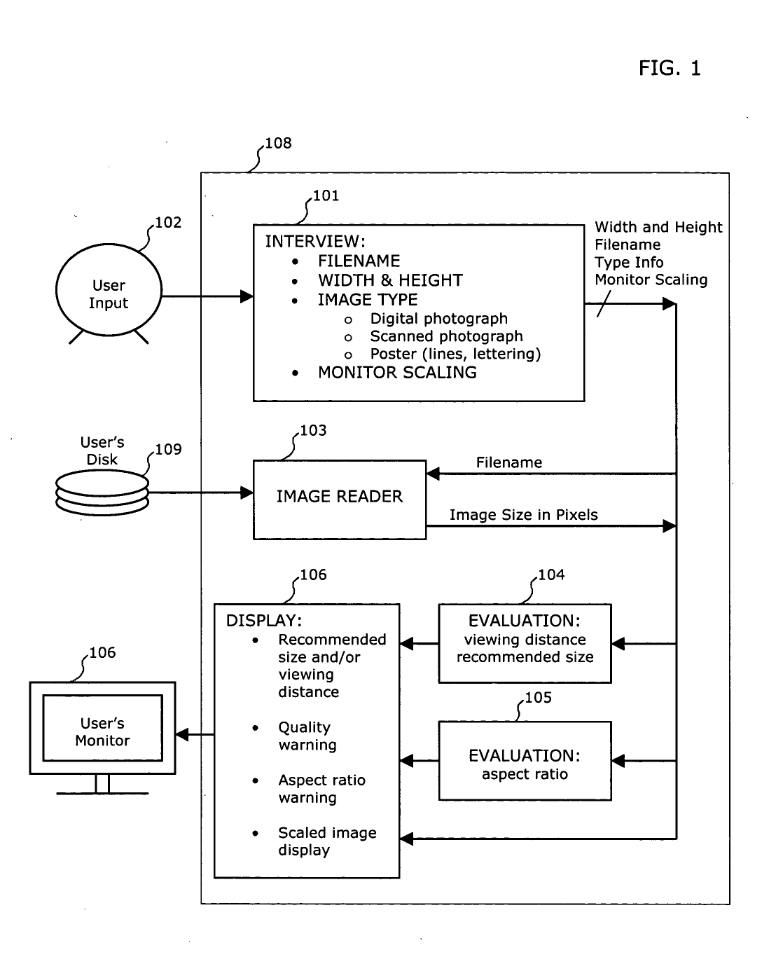

Turning first to FIG. 1 there is shown a block diagram of a digital print size evaluation method 108 in accordance with the present invention. The first step of the method is an interview means 101 which requests input from a user. The user responds by means of an input device at the user's disposal 102 such as a keyboard or mouse, to specify an image file and a requested print size width and height which the user prefers. The user is also allowed to specify monitor scaling information and image type. The possible values of image type include but are not limited to digital photograph, scanned image, and poster containing lettering or sharp lines.

If monitor scaling is not specified, a predetermined default will be used. For example, a common monitor scaling factor in use at the present time is 17 inches diagonal and 1024 pixels width. If the user's monitor is actually 16 inches or 1280 pixels, this will affect the validity of the results display only slightly, and can usually be ignored. The predetermined default can be changed from time to time to reflect monitor technology in common usage.

With regard to image type, since digital photography is coming into increasingly prevalent usage, an image type of digital photograph is a prudent default. The digital print size evaluation method can assume that the size of the image file specified is the same as the size of the original digital photograph, or for more precise results the resolution of the original photograph in terms of the camera's megapixel rating can be solicited from the user in step 101. A suitable default for camera megapixel rating would be an average of typical available cameras, such as 3 megapixels. For the scanned image type, the size of the image that was scanned and the scanning density will be solicited in the interview step 101. Suitable default values can also be assumed for the scanning parameters, such as for example the common source print size of 4 inches by 6 inches, and a scanning density of 300 pixels per inch. All default values may change from time to time as the average parameters of equipment available to users changes, and the present invention is not intended to be limited to the default values specified.

In the next step, an image reader means 103 reads the image file and determines the pixel dimensions, the width and height in pixels, of the image represented in the file specified by the user. A pixel is a set of numbers representing the intensity of each primary color at one point in the image. The image can be read from the user's disk 109 as shown in the figure, or from any other device connected to the user's computer, such as a scanner or the internet.

Based on information obtained in the interview step 101 and the image read step 103, two evaluation steps are performed.

The quality or first evaluation step 104 determines the quality of the requested print size, and expresses this quality as recommended viewing distance. The relationship between viewing distance and the spatial resolution capability of human vision is well known. At 3 feet, humans can resolve a little better than 75 pixels per inch, and this has traditionally determined the size and resolution of such devices as computer monitors. Ordinary paper has a spatial resolution equivalent to about 150 to 200 pixels per inch, and can be viewed as close as one foot without noticing fibers from which the paper is made.

What is not well known is how to explain image quality to ordinary users in such a way that they will be able to make use of the information. In the prior art based on film technology, many years of experience have led to heuristic guidelines regarding what print size can be satisfactorily obtained form a certain film type, exposure and negative size. These guidelines assume the print is made directly from the negative, and may not apply when a scan of the negative, or worse yet a scan of a print from the negative, is used for printing. In a digital image file, whether from a scan or a digital photograph, the image is divided into discrete pixels, and the prior art calls for expressing print quality in terms of pixels per inch, or similar measure of resolution. Expressing quality in terms of pixels per inch is misleading because of confusion between pixels and printer dots, which are less than pixels, and because various image processing steps the user might employ can change the pixel density and affect quality in ways the user may not understand. This part of the problem is solved in the present invention by computing image quality based on the effective print pixel density which is the minimum scaled pixel density that can be inferred from the image source, from known processing steps such as scanning, or from the final image file.

In the case of a scan from a paper source, the limiting resolution of the paper can be inferred from the scanning density and source image size. The ratio of the source image size to the requested print size provides a scaling factor which when multiplied by any scanning density estimate provides an equivalent print pixel density estimate. Based on the scanning density specified by the user, a scanned print pixel density is derived by this method. Based on an estimate of the resolution of photographic paper as described above, a source print pixel density is derived. Based on the file pixel dimensions and the requested print size, a file print pixel density is derived. The minimum of these three values is taken as the effective print pixel density.

In the case of a digital photograph, the camera's megapixel rating combined with the requested print size provides an estimate of source print pixel density. The minimum of source print pixel density and file print pixel density is taken as the effective print pixel density.

A poster image type is assumed to be digitally generated, and so the file print pixel density is taken as the effective print pixel density.

Once the effective print pixel density is estimated, the quality is expressed to the user in terms of estimated viewing distance, which is more useful to the user than a pixel density specification.

The final conversion of pixel density into a viewing distance recommendation depends on the content of the image. It is not well known is how to take into account various types of image content without actually being able to see and understand the image, which computers cannot at this time do. If a human print service provider is utilized, the service provider can make this subjective determination after a user has submitted a print request, but this occupies the service provider's time and causes delay when the user must be contacted. If the printing process is fully automated, or local to the user's computer, no human other than the user is involved. The user can see and understand the image, but cannot be assumed to have the expertise to use this understanding to translate a pixel density specification into a true notion of expected print quality. The present invention solves this problem by asking the user a simple question about the image, which is done in step 101. If the image is a poster type, defined to the user as containing straight lines, lettering, or other sharp edges, all of which constitute non-photographic design matter, then a higher pixel density requirement for a given viewing distance is used to estimate quality. All other image types are assumed to be photographs of natural objects with indistinct edges caused by focus, lighting and background clutter, and a lower requirement for pixel density is used to estimate quality, generally about half that used for poster type images.

Still another thing that is not well known is the optimum setting of the relation of viewing distance to pixel density. Tables of viewing distance and various measures of image density in the prior art generally set too high a quality standard. Purveyors of film technology and digital printing equipment depend on the testimonials of professional reviewers to describe their product to users, and so the standards tend to be set very high. A print service provider who makes available a quality guidance and preview system such as described in the present invention need not be encumbered by the opinions of professional reviewers, but instead depends directly on the opinions of customer users. Since pricing of digital printing is customarily proportional to the size of the print, it is in the interest of a print service provider to encourage the largest print size with which the user will likely be happy. A service provider employing the present invention to guide users in selection of print sizes might, for example, use the above mentioned value of 3 feet recommended viewing distance at 75 pixels per inch for normal images, and 3 feet at 150 pixels per inch for poster type images. This is about half the pixel density most film service providers would recommend, but has proved quite satisfactory in practice. The present invention is by no means limited to these particular values, and a service provider employing the present invention could set any value deemed practical. A user employing the present invention for local printing could obviously be provided a means to set a personal preference for this conversion.

Having determined the effective print pixel density, the image type, and the conversion factor from pixel density to viewing distance, the next job of the viewing distance evaluation step 104 is to compute the recommended viewing distance by simple ratio and proportion. For example, if the pixel density is 37.5 pixels per inch, half of the base 3 foot reference 75 pixels per inch, then the recommended viewing distance would be 6 feet.

If the user omits a requested print size, then the job of the quality evaluation step becomes one of recommending a print size. This is done assuming a predetermined minimum viewing distance, and dividing one of the image pixel dimensions by the minimum pixel density associated with that viewing distance to obtain a maximum print size. A different viewing distance and thus pixel density may be assumed for different types of images, for example 72 pixels per inch for photographs or scans, and 120 pixels per inch for posters. The present invention is by no means limited to these particular values. The skilled practitioner will easily see that an input could be provided in step 101 for a user to provide a customized minimum viewing distance.

The aspect ratio determination or second evaluation step 105 can take one of two forms. Aspect ratio is the ratio of width to height of an image. If the aspect ratio of the requested print differs from the actual image being printed, the image has either to be stretched or cropped. The user may be unpleasantly surprised by either stretching or cropping if it is too great and was not intended. If the user specifies both width and height of a requested print size, then the evaluation step 105 determines if the requested aspect ratio matches the image aspect ratio within a predetermined limit. If the user only specifies width, or only specifies height, the aspect evaluation step 105 computes the omitted dimension so as to maintain the aspect ratio of the original image.

To complete the method, step 106 displays the original request information, the results of all evaluations, and the image scaled approximately to print size using the display monitor 107 attached to the user's computer, or any display device. Monitor scaling information together with image file width and height are used to perform image scaling. If the scaled image will not fit on the user's display area, which is highly likely, a portion of the image can be displayed with scroll bars or other means provided for panning to any part of the image that might concern a user.

Even though recommended viewing distance is likely more meaningful to users than pixel density, its significance may still escape some users, particularly those that pay scant attention to numbers, or are in a hurry and overlook what they might consider an obscure piece of information. One aspect of the present invention is that the viewing distance is further interpreted by the display step 106 as a quality warning, which may take several forms. If the minimum recommended viewing distance is unusually small, for example less than 2 feet, the quality warning may advise that the image is of very high quality and may be printed in a larger size if the user so desires. If the minimum recommended viewing distance is moderate, for example between 2 and 4 feet, the quality warning may advise that the requested size is about right, encouraging the user to proceed with placing an order. If the viewing distance is only a bit larger than usual, for example between 4 and 6 feet, the quality warning may ask the user to check and be sure the viewing distance is acceptable. If the viewing distance is still larger, for example between 6 and 12 feet, the quality warning may strongly suggest that a smaller print size be requested, as most users are unlikely to be happy with an image in this quality range. Large type, color, or a popup message may be used to make sure the user sees this important warning. If the viewing distance is larger still, then the quality warning will display an extremely prominent warning that most likely there was some error in providing information about the image, as it would seem to be totally unsuitable for printing. The present invention is by no means limited to these particular values, and they could be changed by a print service provider or a user to suit the provider's or user's taste and experience.

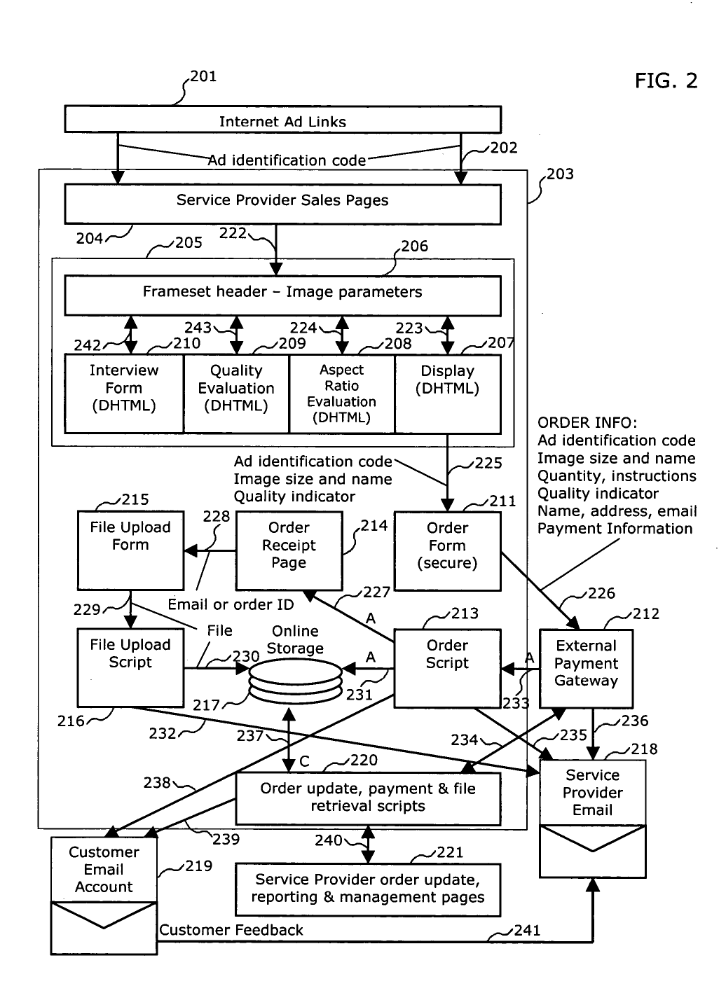

Turning next to FIG. 2 there is shown a schematic block diagram of a digital image print size evaluation system with DHTML implementation and ordering in accordance with the present invention. DHTML stands for Dynamic HTML, and HTML stands for Hypertext Markup Language, a widespread method of representing, formatting and linking information for use by computers over a network, such as the internet. HTML provides a fixed or static representation, defined in advance of access by users. DHTML provides a changeable representation, defined after interaction with users, usually by means of scripts, which write HTML based on the user's actions or requests. These may be scripts embedded in or associated with the HTML and running on the user's computer, such as JavaScript, or scripts in languages such as Perl running on a web host and accessed through the CGI or common gateway interface. The present invention is by no means limited to implementation using any of these particular choices of languages or facilities, and the experienced practitioner will recognize that many choices are available which would suffice. All scripts and DHTML pages necessary to implement a preferred embodiment of the present invention, according to FIG. 2 and including all specific source files mentioned in the following description, are found in the computer program listing appendix.

FIG. 2 area 203 includes the elements of a digital image print size evaluation system with ordering. One method of obtaining customers or users for this system is to place ads or paid search listings on the internet, shown as block 201. The hyperlinks 202 from these ads 201 to the system 203 may contain coded link information in the form of an ad identification code parameter appended to the link, which records the source of the link. For example, the coded link information for a paid search listing might contain the name of the listing service and the keyword or phrase under which the listing appears. The coded link information will be recorded in a cookie on the user's computer, so that if the user later places an order, the link information can be retrieved from the cookie and saved with the order for use by a print service provider in optimizing the placement of ads. Cookie is a technical term referring to a facility provided by web browsers for storing information associated with the user's use of a particular website. The link information is recorded by any page in the service provider's website that is the target page of the link. The link information is then retrieved from the cookie by any order precursor page, which is a page linking to the order information collection page, and passed via link parameters to the order information collection page. This arrangement allows the order information collection page to be placed on a secure server which the user's web browser might identify as a separate website, and to which it might not provide the cookie information directly because of web browser security protocols. The target page may be any page in the print service provider's website, such as the sales pages 204 describing the services provided, or the print size evaluation pages 205. The order precursor page also may be any page in the print service provider's website, such as the sales pages or print size evaluation pages.

Within the service provider's sales pages 204, hyperlinks 222 will refer the user to the print size evaluation pages 205 which in the embodiment described in FIG. 2 constitute a frameset. The experienced practitioner will recognize that many other embodiments are possible. The frameset header 206 is the target of the links 222 and is used to store image parameters such as the name of the image file, and the requested print size. Prominently displayed within the frameset is the interview form 210, which provides the means for the user to specify a requested image size and type, and designate an image file. The interview form contains script elements, which store the provided information in the frameset header 206 by means of script variable references 242 for use by the other elements of the print size evaluation.

When the user makes a request for an evaluation, the quality evaluation script 209 and aspect ratio evaluation script 208 are invoked to retrieve via script variable references 224 and 243 the image parameter information from the frameset header 206 and perform the evaluation. They store the results of the evaluation back in the frameset header and then invoke the display function 207, which retrieves the evaluation results and request information again via script variable references 223 and displays the scaled image and the results of the evaluation as described above.

In the computer program listing appendix, file wizard.htm corresponds to the frameset header 206, and file wizardf.htm contains the interview 210, quality evaluation 209, aspect ratio evaluation 208 and display 207 all as a single combined element of the frameset. The combined element determines from the information stored in the frameset header what function it is being asked to perform. For the display function, it generates HTML statements to display the image with the desired scale factor. The interview form is always displayed, and contains the values last used, allowing convenient iteration by the user. To perform a new function, the combined element stores information about the new function in the frameset header and initiates a reload of itself. During the reload, it performs the new function.

The present invention is not limited to this particular embodiment, and the experienced practitioner will recognize that other embodiments are possible. In particular, rather than accomplishing all the functions within a frameset, cookies or link parameters could pass information between various elements of the print size evaluation pages. The image parameters could also be stored on a host computer, retrieved by means of a session identifier, and scripts on the host computer used to generate the DHTML elements.

When a user is ready to accept the results of an image print size evaluation and place an order, the user clicks on a link 225 in the display element 207 which transmits the image size and name, ad identification code and quality indicator such as viewing distance to an order information collection form 211 hosted on a secure web server so that credit card and user personal information can be collected. When complete, the order information is communicated to a payment authorization service 212 via a first communication means 226 such as the common gateway interface. Each payment authorization service operates slightly differently, and the interface to such service represented by the order form in the file printorder.htm in the computer program listing appendix is merely representative. The flow of events surrounding the external payment service or gateway 212 in FIG. 2 is likewise representative.

The payment authorization service 212 notifies the print service provider's order script 213 whether the user's payment information is acceptable, and transmits this notice together with all the aforementioned order information (designated A in FIG. 2) to the order script by a means 233 such as the common gateway interface. The payment authorization service may also send a notification of the order by email communication 236 to the service provider's email account 218. The order script generates an order receipt page 214 for display to the user containing the order information and approval status A via web hypertext transfer protocols 227, and may send a receipt via email communication 238 to the user's email account 219. The order script also records the order information and status A in an online database 217 with which it communicates by means of script commands 231. A representative order script is given as file printorder.cgi in the attached computer program listing appendix.

The user clicks a link 228 on the order receipt page to activate the file upload form 215, which again allows selection of the file. For security reasons, web browsers do not allow the file to be selected by DHTML means. An upload form is given in file return.htm of the computer program listing appendix. The file is then transmitted via a second communication means 229 such as the common gateway interface to the service provider's online storage 230. It is common that a file upload script 216 may be required to mediate this transfer and place the file into storage by means of script commands 230. This script may also send a file upload notification via email communication 232 to the service provider's email account 218. An example file upload script is given in file fupmcp.cgi of the computer program listing appendix.

Having accepted the pre-evaluated order, the print service provider may employ additional scripts 220 and private HTML pages 221 communicating via link parameters 240 to process the actual payment via communicating again 234 with a payment gateway service 212, transmit 237 updates to the order database 230, download 237 image files, and notify users via email 239 of order status and shipping information. To make a complete online business system, the service provider will accept feedback from customers in some form, such as via email 241. Details of these steps may vary according to the service provider's resources and requirements. A sample order management page mcp_reports.htm and order management scripts printupd.cgi, mcp_dscan.cgi and mcp_report.cgi are also given in the computer program listing appendix.

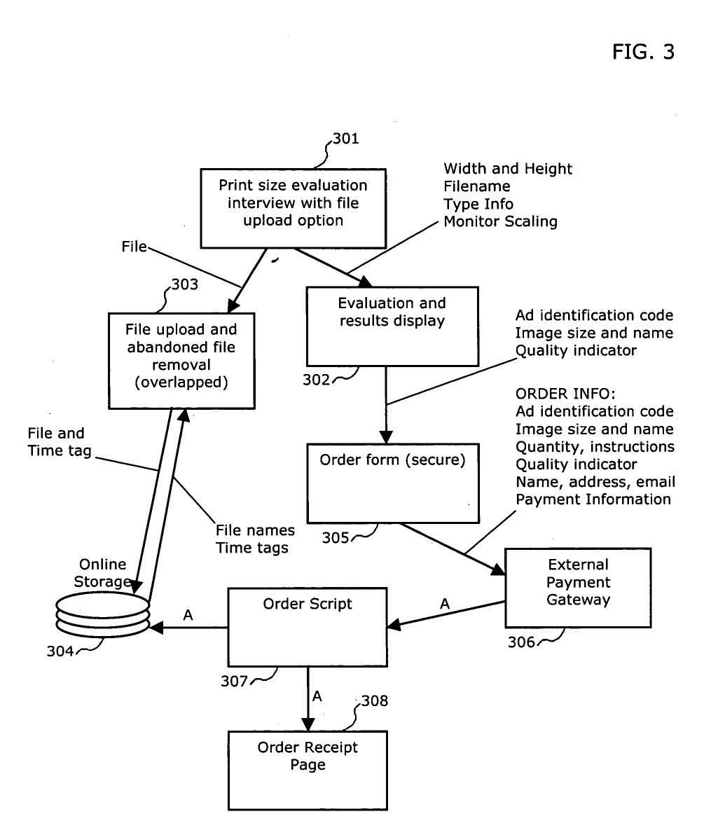

Turning now to FIG. 3 a schematic block diagram of a method for overlapping the file upload with image evaluation and ordering is shown. Experienced practitioners will recognize many arrangements of file uploading with respect to evaluation and ordering, each with advantages and drawbacks. Placing the file upload early in the process assures that the user's file will be in hand when an order is placed, but runs the risk that users will become impatient with the upload, or discouraged by the necessity of multiple uploads if the first file does not evaluate well, and abandon the order process. Placing the file upload on the order form reduces risk of order abandonment, but complicates the order process because the payment gateway likely will not accept a large file, and increases the risk the order process will be abandoned because of failure of the file transfer to complete. Placing the file upload after the order process maximizes the number of customer orders, while requiring occasional follow up by the print service provider with the customer to obtain missing files. Print image files can be many megabytes, up to tens or hundreds of megabytes, such that even with high speed connections there may be upload failures, or users may abandon the upload process.

The method shown in FIG. 3 will substantially improve the usability of the digital image print size evaluation process with ordering by overlapping the file upload process, which may proceed unattended, with the interactive processes of image evaluation and ordering. This will reduce the rate of user abandonment, decrease the total time required to evaluate an image and place an order, and increase user satisfaction.

In FIG. 3 the user initiates the evaluation of a print image with an interview step 301 just as in the method of FIG. 1 step 101, with the exception that in this case the user is asked, or provided an option to specify, if the user wishes to upload the file while the evaluation is taking place. In the case where this option is exercised, when the user requests an evaluation a separate overlapped evaluation process 302 is initiated, while simultaneously the file upload proceeds from the original process 301. Alternately, the file upload can be initiated as the new process, and evaluation can proceed in the original process. The file is transmitted in the usual manner, such as for example by a common gateway interface CGI using internet protocols, or any suitable file transfer protocol, to step 303 which oversees the storing of the file along with an upload time tag in the print service provider's online storage 304.

The print image evaluation proceeds as previously described, but does so in a separate process 302. The new process activation is provided by any convenient means, such as but not limited to the opening of a new browser window with a script command. The interview information from step 301 is provided to the new process also by any convenient means, such as but not limited to link parameters or cookies, as previously described. If the new process is associated with a new browser window, often called a popup, then it will naturally overlay the file upload process and attract the user's primary attention. It may be desirable to warn the user that a popup process will be used, and request that the user temporarily disable any software the user might be employing to stop popup's.

In the computer program listing appendix, the file wizardf.htm, which corresponds to steps 301 and 302 in FIG. 3, provides an option to initiate an overlapped file upload process 303 by opening a small new window which becomes the target of the upload form if the user clicks a button requesting the overlapped upload.

If the results of the evaluation are accepted by the user, the digital print evaluation with ordering proceeds to an order information collection step 305 as previously discussed, and to a payment services provider 306 to process payment or authorization as the print service provider wishes. The results of step 306 designated as A include the order information, the evaluation results, and the authorization information, and are passed by a communication means such as but not limited to a common gateway interface internet protocol to the print service provider's order processing step 307, which records the order in the online data area 304 and displays a receipt or confirmation message to the user 308. The payment gateway and the order processing step may have other interfaces and functions as have been previously described, such as but not limited to sending notification emails.

One further function must be performed for this method to work well. Abandoned files for which there is no print services order should be automatically eliminated to avoid clutter and conserve space in the online storage area 304. This can be done at any step that has ready access to the online storage area, or in a separate step on an automatic timer, or can be initiated by the print service provider. In FIG. 3 it is shown as being performed by the file upload step 303, with assistance from the order processing step 307. As previously discussed, the upload step stores a time tag with each file. Whenever a new file is uploaded, the upload step checks how long all time tagged files have been stored against a predetermined limit. All files for which the limit has been exceeded are removed. When an order is placed using a specific file that has been uploaded, the order processing step 307 locates and removes the time tag from that file so that it is no longer checked for deletion by the upload step 303. In this way, unused files are automatically removed, and the introduction of an overlapped file upload and print size evaluation process provides the intended benefits without causing unwanted clutter and file cleanup duties for the print service provider. Since most file systems automatically time tag files, it is also sufficient to compare the uploaded files to the order database, and if a file is older than the predetermined interval and not associated with an order, it can be deleted.

The novel aspect of the overlapped file upload aspect of the present invention is not in the commonplace overlapping of functions, but a combination of two specific and non-obvious insights.

The first insight is that file uploads are easily overlapped with other functions. Experienced practitioners expect to overlap only downloads, a feature automatically provided by web browsers, whereas at the current time upload overlapping must be accomplished by the script tricks described in this disclosure, using a combination of browser features intended for other purposes.

The second insight is that a specific process, in this case the print size evaluation with ordering, may be usefully arranged with an overlapped file upload, conferring benefits beyond just the time efficiency. Of course, the print size evaluation with ordering system accrues particularly large time benefits because there are multiple time consuming interactive steps that may be overlapped with the upload, and digital printing also involves large files, for which upload time may be noticeable even over large connections. But the positioning of the upload early in the process increases the likelihood that the file associated with an order will actually have been uploaded, and the overlapping of upload with evaluation and ordering allows this positioning without making the evaluation and order process in any way contingent on a successful upload process. File uploads often fail, either through user abandonment, loss of the communication link, or server load shedding. Even if the file upload fails repeatedly, the order can still be processed. The user may provide the file by another means, such as but not limited to email, physical mail, or posting of the file to a location from which the print service provider can retrieve it.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. System for evaluating and recommending digital image print size comprising:
a user interview means for specifying an image file, a requested print size width and height, and an image type;
an image reader means for determining the pixel dimensions of an image in said image file;
a first evaluation means for determining print pixel density of said image at said requested print size, and determining acceptable viewing distance based on a predetermined relation of viewing distance to print pixel density for each image type;
a second evaluation means for determining if the requested print size alters the aspect ratio of said image by more than a predetermined amount; and
a display means for showing results of the evaluations
whereby quality issues arising from users attempting too much enlargement are minimized, and delay when requesting such enlargements from a print service is eliminated.

2. System for evaluating and recommending digital image print size as claimed in claim 1 wherein
said display means produces a conspicuous warning if viewing distance exceeds a predetermined amount
whereby user is encouraged to request a print size with which user is more likely to be satisfied.

3. System for evaluating and recommending digital image print size as claimed in claim 1 wherein
said interview means allows requested print size to be omitted; and
said first evaluation means produces a print size recommendation based on a predetermined viewing distance
whereby a user who is uncertain how much enlargement to request obtains a useful maximum estimate.

4. System for evaluating and recommending digital image print size as claimed in claim 3 wherein
said interview means allows the specification of only one of requested print size width and height; and
said first evaluation means produces a print size recommendation maintaining the aspect ratio of the image and determines acceptable viewing distance
whereby the user is relieved of having to make aspect ratio calculations.

5. System for evaluating and recommending digital image print size as claimed in claim 1 wherein
said display means shows the image scaled to the approximate requested print size
whereby the user can obtain an approximate visual representation of print quality.

6. System for evaluating and recommending digital image print size as claimed in claim 5 wherein
said interview means provides for determining the scaling characteristics of the said display means
whereby the user can adjust the scaled display according to the characteristics of a display device to more accurately approximate requested print size.

7. System for evaluating and recommending digital image print size as claimed in claim 1 wherein
said user interview means allows specification of an image type that contains sharp lines and lettering; and
said first evaluation means increases the recommended viewing distance by a predetermined amount when the image contains sharp lines and lettering
whereby an appropriate recommendation is made for images containing non-photographic design matter.

8. System for evaluating and recommending digital image print size as claimed in claim 1 wherein
said user interview means allows specification that the image file was generated by scanning a photograph, and provides for the specification of scan density and original photograph size; and
said first evaluation means determines the recommended viewing distance using an estimate of effective print pixel density based on the minimum of the file print pixel density, scanning print pixel density, and source print pixel density computed using a predetermined estimate of the equivalent pixel density of photographic paper
whereby an appropriate recommendation is made for over-scanned and under-scanned images.

9. System for evaluating and recommending digital image print size as claimed in claim 1 further comprising
an order information collection means for specifying user address and payment information;
a first communication means for transmitting user print request, file, evaluation, address and payment information to a print service provider;
a second communication means for transmitting the image file being evaluated to a print service provider; and
a payment authorization means for assuring the user payment will be completed if said service provider accepts said print request
whereby the results of the evaluation and recommendation are automatically recorded with the user's order and service provider may proceed with confidence in payment and user satisfaction, without having to make refund credits or collect secondary payments if changes are necessary to the print request.

10. System for evaluating and recommending digital image print size as claimed in claim 9 wherein
said user interview means is an HTML form in a web page;
said image reader means is a DHTML web page which uses a web browser to display the file and obtains pixel dimensions using script commands;
said first evaluation means is a web page script stored on a web host and running within a web browser on the user's computer;
said second evaluation means is a web page script stored on a web host and running within a web browser on the user's computer;
said display means is a DHTML web page;
said order information collection means is an HTML form in a web page;
said first communication means is a web based common gateway interface to a database on a web host computer for recording said information in combination with email for providing rapid notification to the service provider;
said second communication means is a web based file upload means for storing the image file on a web host computer and an email means for providing rapid notification to the service provider; and
said payment authorization means is a common gateway interface to a payment gateway provider
whereby the entire system is implemented using reliable web based infra-structure and resources that the service provider can obtain at low cost.

11. System for evaluating and recommending digital image print size as claimed in claim 10 wherein
said user interview means, said first and second evaluation means and said display means are a single HTML frameset
whereby the interview means is continuously available for making changes as results are displayed and communication among the interview, evaluation and display means is simplified.

12. System for evaluating and recommending digital image print size as claimed in claim 10 wherein
a target page automatically records coded link information revealing the source of the user's referral to the system for evaluating and recommending digital image print size;
an order precursor page retrieves the coded link information and transmits this to said order information collection means;
said first communication means transmits coded link information to said database on said web host computer;
whereby a print service provider may monitor and optimize the effectiveness of paid referrals.

13. Method for evaluating and recommending digital image print size comprising the steps of:
interviewing a user to select an image file and specify requested print size width and height;
reading an image file to determine the pixel dimensions of the image;
determining acceptable viewing distance based on a predetermined relation of viewing distance to pixel density;
determining if the requested print size would alter the aspect ratio of the image by more than a predetermined amount; and
displaying the results of the determinations.

14. Method for evaluating and recommending digital image print size as claimed in claim 13 further comprising
recommending a maximum print size;
warning if requested print size aspect ratio differs from image aspect ratio by more than a predetermined amount; and
warning if said acceptable viewing distance is larger than a predetermined amount.

15. Method for evaluating and recommending digital image print size as claimed in claim 14 further comprising
recording order information including requested print size, file name, shipping address, and user payment information;
transmitting order information to a print service provider; and
transmitting the image file to said print service provider.

16. Method for evaluating and recommending digital image print size with overlapped file upload comprising the steps of:
interviewing a user to select an image file and specify requested print size width and height;
uploading the image file to an online storage while continuing with the following steps;
evaluating the image file print quality at the requested size and displaying the results;
obtaining order information associated with the specified file from the user;
authorizing payment based on the order information; and
recording the order and payment authorization information in the online storage.
